(19) United States
(12) Patent Application Publication
(10) Pub. No.: US 2012/0224725 A1
(43) Pub. Date: Sep. 6, 2012

(54) DUAL WIRELESS/OPTICAL AUDIO SWITCH

(76) Inventors: Yohan Paul PREVOT, Bradenton, FL (US); Kurt Fredric Ditzel, Troy, MI (US)

(21) Appl. No.: 13/402,790

(22) Filed: Feb. 22, 2012

Related U.S. Application Data
(60) Provisional application No. 61/445,549, filed on Feb. 23, 2011.

(51) Int. Cl. H02B 1/00

(52) U.S. Cl. 381/123

(57) ABSTRACT

A dual wireless/optical audio switch system comprised of a set of optical input ports for home gaming systems, television, video streaming devices, a user selection panel, a signal routing circuit, two radio frequency transceiver units, a touch controller unit, a USB power control unit, a wireless remote, a wireless USB soundcard, and wireless headset. The system allows for the user to have multiple optical audio outputs from electronic devices connected to its inputs as well as receive wireless streaming audio from a wireless USB soundcard that is also able to wirelessly stream audio to a headset. Through user selection from the system front touch panel or wireless remote, the audio signal of choice is multiplexed to a single optical output port to be connected to a home entertainment receiver.

### RELATED APPLICATION

The present application is based upon provisional patent application, Application No. 61/445,549 filed Feb. 23, 2011, the subject matter of which application is incorporated herein by reference.

### BACKGROUND OF THE INVENTION

Present-day optical audio switching electronic devices utilize a plurality of optical audio input devices with a smart TV, video streaming module, a gaming system, and in many cases, an infrared remote which controls the multiplexing corresponding to choosing an input, out of several, to be forwarded to the output. Some conventional optical audio switch includes a mechanical knob with its internal multiplexing performed by a single fiber optic cable while others employ the use of analog switches. In such conventional system the user is limited to the number of inputs of the audio switch as well as functionality when incorporated in a home audio entertainment system.

There are numerous optical audio switches where each of these systems has advantages and disadvantages that will be taken into consideration when designing the electronic system. While known devices fulfill their respective, particular objectives and requirements, the prior art does not describe a dual wireless/optical audio switch as disclosed herein. In this respect, the dual wireless/optical audio switch according to the present invention substantially departs from the conventional concepts and designs of the prior art, and in doing so provides an apparatus primarily developed for the purpose of multiplexing audio sound from optical outputs of electronic peripherals, wireless audio USB soundcard and through user audio selection, outputting such selection to the input optical connector of a surround sound system receiver or other receivers.

### SUMMARY OF THE INVENTION

The following specification of method and system for a dual wireless/optical switch interface system is disclosed.

The dual wireless/optical audio switch is comprised of a plurality of input ports for coupling optical or wireless audio data from a plurality of input devices through a complex programmable logic device (CPLD) which multiplexes and decodes said data from said input ports to the output port of the system and to the optical input of a home entertainment receiver. The system controls the multiplexer through a user control panel or alternatively through a wireless remote control. In addition to the optical inputs, the system may also receive audio input from a wireless audio streaming device. The wireless streaming device consists of a universal serial bus (USB) wireless audio transmitter module that connects to external devices, such as laptops or desktops, to wirelessly stream music to the dual wireless/optical audio switch. As an added feature, the wireless streaming device may wirelessly stream audio to a headset. A system in accordance with the present invention allows for a user to have a gaming system, television, or video streaming device connected to a central unit for multiplexing audio signals to a single output connected to a home entertainment system as well as employing the use of a standalone USB soundcard to a headset.

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims attached. It is therefore an object of the present invention to provide a new and improved dual wireless/optical audio switch which has all of the advantages of the prior art electronic switching devices and none of the disadvantages.

### BRIEF DESCRIPTION OF THE DRAWINGS

The invention will be better understood and objects other than those set forth above will become apparent when consideration is given to the following detailed description thereof. Such description, appended claims makes reference to the annexed drawings wherein:

FIG. 1 is a front perspective view of a human interface panel, in accordance with one embodiment of the present invention;

FIG. 2 is a back perspective view of a cable sockets interface, in accordance with one embodiment of the present invention;

FIG. 3 is a block diagram view of an electronic interface board, in accordance with one embodiment of the present invention;

FIG. 4 is a block diagram of an electronic system, in accordance with one portion of the present invention for wireless network operation;

### DETAILED DESCRIPTION OF THE INVENTION

The present invention relates to a dual wireless/optical audio switch system that uses a plurality of optical and wireless input devices to multiplex to a single optical output connected to the optical input of an entertainment receiver. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting. As such, those skilled in the art will appreciate that the conception, upon which this disclosure is based and be able to understand some aspect of at least one embodiment described in the following specification.

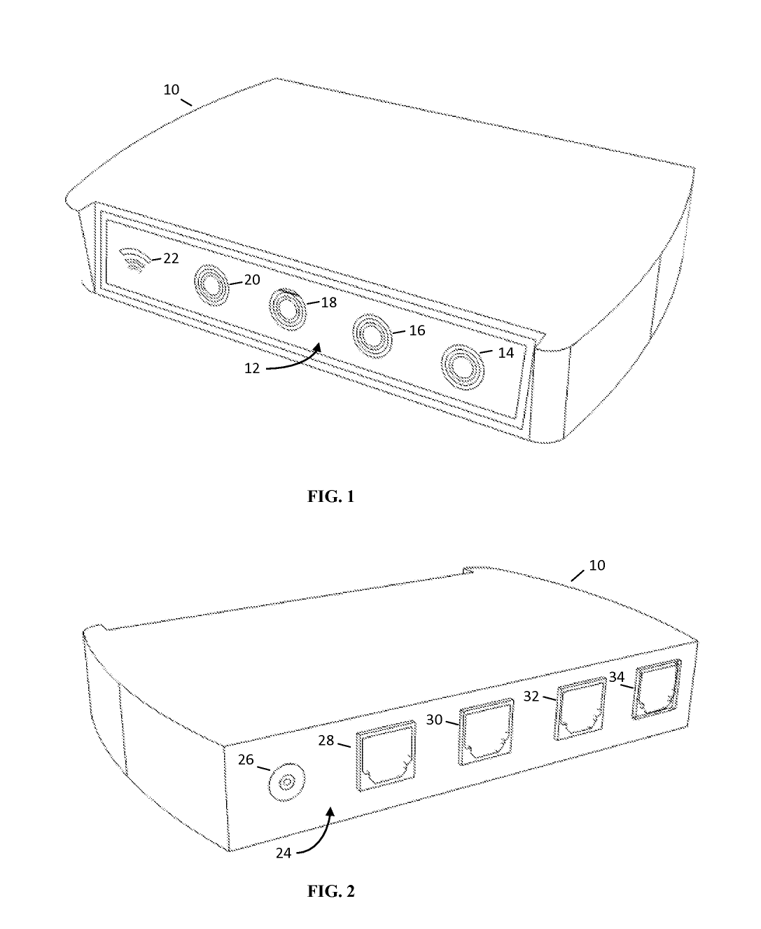

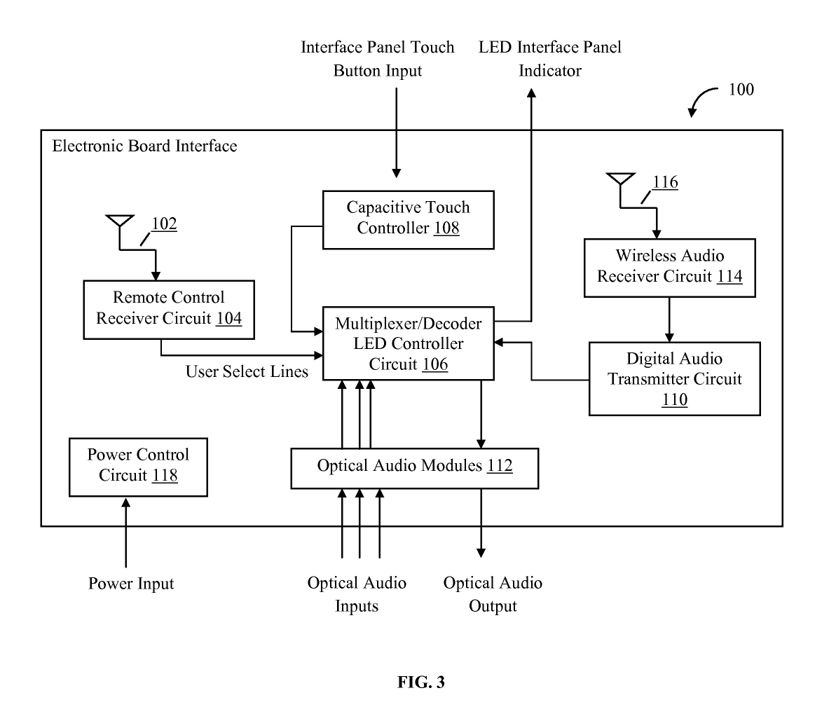

Referring now to the invention in more detail, in FIG. 1 to FIG. 2, there is shown an embodiment of a digital wireless/optical audio switch device 10 comprised of a human interface panel 12 and a Toslink fiber optic cable connection panel 24. The user interface panel includes touch buttons and indicators as one means of control signal for the selection of audio output of the system. Namely a first touch button and indicator 14 used for on/off operation of the system, a second touch button and indicator 16 signifying a first optical input, a third touch button and indicator 18 signifying a second optical input, a fourth touch button and indicator 20 signifying a third optical input and a fifth touch button and wireless indicator 22 signifying wireless input selection. The Toslink fiber optic cable connection panel 24 illustrated in FIG. 2 provides for an interface to electronic devices that support optical audio output ports. These modules transmit data optically and light is then converted to a digital data signal by the dual wireless/optical audio switch optical input modules. Namely first port, a power cable connector 26, second port a fiber optic cable input 28, third port a fiber optic cable input 30, fourth port a fiber optic cable input 32 and fifth port a fiber optic cable output 34.

In more details, still referring to FIG. 1-3, a typical embodiment of a digital optical audio switch system 10 includes an internal electronic board interface 100 that contains electronic circuitry for the processing of the optical audio signals as well as the remote control wireless signals and wireless USB soundcard signals. FIG. 3 is a block diagram of an embodiment of the electronic board interface 100. In the example embodiment of FIG. 3, the electronic board interface 100 comprises a multiplexer/decoder and light emitting diode (LED) controller circuit 106 that includes circuitry of at least one field programmable gate array (FPGA) or complex programmable logic device (CPLD) that is in operative communication with the capacitive touch controller 108, digital audio transmitter circuit 110, optical audio modules 112, and remote control receiver circuit 104. Its function is to receive the various data signals from nearby modules, encode the data, and identify the input device that is to have its data transmitted to the output optical module of the optical audio modules 112. Additionally, it will activate the proper indicator 14, 16, 18, 20 on the human interface panel 12 illustrating which touch button 14, 16, 18, 20 was triggered or which signal from the remote control receiver circuit 104 was received.

In one implementation of FIG. 3, a printed circuit board antenna 102 is connected to a remote control receiver circuit 104 that includes circuitry from a low power radio frequency transceiver chip that operates in the 2.4 GHz ISM band. Circuit 104 is configured to receive wireless signals from an external remote control operating as master device in a low power wireless network. The received wireless signal from the remote control receiver circuit 104 is comprised of user selection signals to be transmitted to multiplexer/decoder and LED controller circuit 106 signifying which audio input is to be connected to the audio output of the system or on/off operation of the system. In another implementation, the capacitive touch controller 108 includes circuitry for a capacitive sensor driver with built in signal processing capabilities. Its input signals are obtained from the human interface panel 12 of the digital wireless/optical audio switch device 10. When a touch button 14,16,18, 20 is touched, the capacitive touch controller 108 activate the proper signal to the multiplexer/decoder and LED controller circuit 106 signifying which audio input is to be routed to the output optical audio module of the optical audio modules 112 or on/off operation of the system. Utilizing the wireless remote control and human interface panel 12, the user is given a plurality of choices as to how to operate the digital wireless/optical audio switch device 10.

As further shown in FIG. 3, the optical audio modules 112 is comprised of a plurality of input optical audio modules and a single optical audio output module. The inputs are obtained with connections to the system with fiber optic cables inserted into the fiber optic cable inputs 28, 30, 32 of the Toslink fiber optic cable connection panel 24. All input signals are in optical audio format that is converted to a digital signal by the optical audio modules 112 of the electronic board interface 100 and transmitted to the multiplexer/decoder and LED controller circuit 106.

In the example embodiment of FIG. 3, the electronic board interface 100 contains an additional printed circuit board antenna 116 and a wireless audio circuit 114 in operative communication with the digital audio transmitter circuit 110. The wireless audio circuitry 114 contains circuitry for low power wireless transmission and reception of digital audio. It includes a wireless protocol and coexistence mechanism to reduce interference with other 2.4 GHz radio systems and can control external devices such as the digital audio transmitter circuit 110.

In operation, the multiplexer/decoder and LED controller circuit 106 monitors the input signals from the remote control receiver circuit 104 and capacitive touch controller 108. Once a change in the input signals is detected, the multiplexer/decoder and LED controller circuit 106 decodes whether an input optical audio module in the optical audio modules 112 or digital audio transmitter circuit 110 input is to be coupled to the output optical audio module in the optical audio modules 112. Furthermore, the multiplexer/decoder and LED controller circuit 106 enables the corresponding indicator 14, 16, 18, 20 on the human interface panel 12 of the digital wireless/optical audio switch device 10 to signify which audio input selection was made.

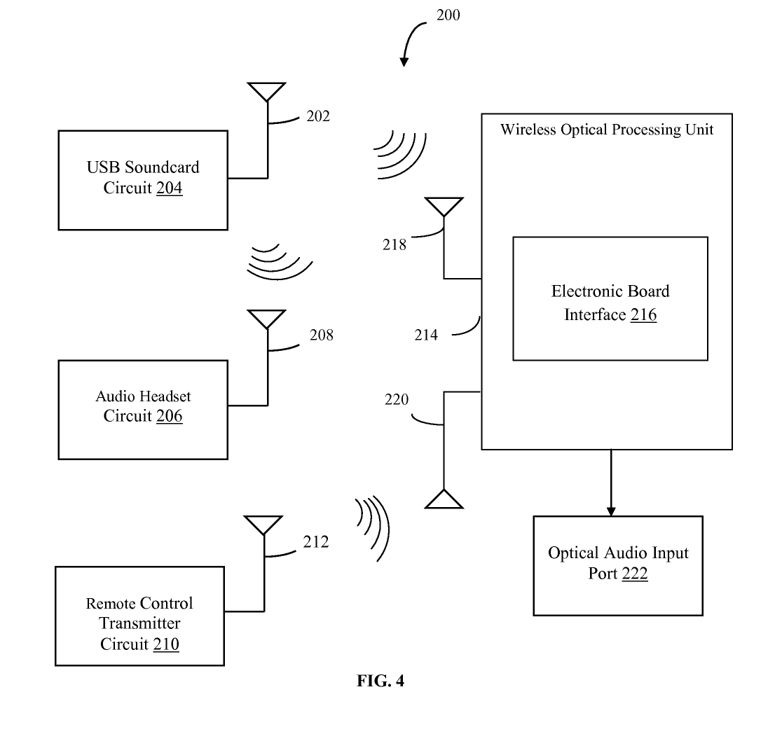

FIG. 4 is a block diagram of an embodiment of the wireless audio system 200. The wireless audio system 200 comprises a wireless optical processing unit 214 that includes an electronic board interface 216, a wireless USB soundcard circuit 204 with antenna 202, a wireless audio headset circuit 206 with antenna 208, a remote control transmitter circuit 210 with antenna 212 and an optical audio input port 222. In one implementation of FIG. 4, the electronic board interface 216 and antenna 218 form a wireless audio network with the USB soundcard circuit 204 and antenna 202. Using a star network topology in the 2.4 GHz ISM band, the USB soundcard circuit 204 is the protocol master streaming wireless audio signals to the electronic board interface 216 configured as a protocol slave. Further shown in FIG. 4, a wireless audio headset circuit 206 is included to operate as an additional protocol slave in the audio wireless system 200. With two protocol slaves, a plurality of functions allows the user to either stream music from a laptop or desktop connected with the USB sound card circuit 204 to the electronic board interface 216 or the audio headset circuit 206. In another implementation, a remote control transmitter circuit 210 with antenna 212 wirelessly communicates wireless data to the electronic board interface 216 via antenna 220. This interface allows for a user to control the multiplexer/decoder and LED controller circuit 106 on the electronic board interface 216 as discussed in further detail with respect to FIG. 3.

In the example embodiment of FIG. 4, the wireless audio system further comprises an optical audio input port 222 communicatively coupled to the wireless optical processing unit 214. The optical audio input port 222 can include without limitation a home entertainment receiver and any device or system where an optical audio input port is made available. With this configuration, the electronic board interface 216 through its onboard multiplexer/decoder and LED controller circuit 106 effectively outputs the digital audio data signal to the optical input of a home entertainment receiver.

What is claimed as being new and desired to be protected by Letters Patent of the United States is as follows:

1. A digital wireless/optical audio switch device comprising:
a human interface panel having a plurality of touch buttons, indicators, and a wireless indicator;
the digital optical audio switch device also including a connection panel having a power cable input, one or more fiber optic cable inputs, and a fiber optic cable output; the digital optical audio switch also including an electronic board interface having a wireless remote receiver controller, a power controller, a plurality of fiber optic receiving controllers, a fiber optic transmitting controller, a plurality of touch sensor controllers, and a wireless audio signal controller; and a programmable logic module operatively coupling the components of the electronic board interface.

2. The digital optical audio switch device as set forth in claim 1 wherein the digital optical audio switch device is adapted to accept input optical audio signals from various optical audio output sources with connections to the device are made with fiber optic cables inserted to the fiber optic cable inputs of the cable connection panel, all input signals being in optical format that are to be converted by the fiber optic receiving controller to digital audio signals and fed to the programmable logic module.

3. An interface system for allowing a plurality of inputs to control a processor comprising:
a plurality of input optical audio ports capable of receiving data from one of a plurality of input devices;
a multiplexer/decoder for processing received data from the plurality of inputs from the remote control, touch controller, and optical modules;
an output optical audio port for coupling the output of the said multiplexer/decoder to an input optical port of home entertainment receiver, wherein said plurality input devices share a single link to provide said data to said home entertainment receiver input.

4. The digital optical audio switch device as set forth in claim 1 and further including a wireless audio interface module having a PCB antenna and a USB audio controller.

5. The digital optical audio switch device as set forth in claim 1 and further including a wireless remote control module having an electronic board interface, the electronic board interface including a system on chip controller, a battery power controller and a RF antenna interface, the wireless remote control module being adapted to utilize radio frequency signals to enable non-line of sight operation of the digital optical switch device for the selection of an input audio signal.

6. The digital optical audio switch device as set forth in claim 1 and further including a double ear-pierce wireless headset comprised of a wireless audio interface, the wireless headset adapted to receive streaming audio from a wireless USB soundcard where the signal is transferred to the headset's dual speakers.
